(19) United States
(12) Patent Application Publication
(10) Pub. No.: US 2005/0242153 A1
(43) Pub. Date: Nov. 3, 2005

(54) Stapler

(75) Inventors: David P. Adams, Barrington, IL (US); Joel G. Delman, Chicago, IL (US); Linda Pulik, Chicago, IL (US); Melanie Lyn Conklin, Brooklyn, NY (US); Clifford Krapfl, Chicago, IL (US); Cory William Worth, San Francisco, CA (US); Stephen John Gaynes, McHenry, IL (US); Michael F. De Rossi, Lindenhurst, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 11/110,642

(22) Filed: Apr. 20, 2005

Related U.S. Application Data
(60) Provisional application No. 60/563,733, filed on Apr. 20, 2004.

(51) Int. Cl. B25C 5/02

(52) U.S. Cl. 227/120

(57) ABSTRACT

A stapler includes one or more illuminated features that assist the user in guiding the stack of sheets into the stapler's throat for stapling. The illuminated features help the user intuitively position the stack of sheets in the throat to achieve the desired staple position on the stack of sheets.

### RELATED APPLICATIONS

This application claims priority to U.S. Provisional Patent Application No. 60/563,733 filed Apr. 20, 2004, which is hereby incorporated by reference.

### FIELD OF THE INVENTION

The invention relates to staplers.

### BACKGROUND OF THE INVENTION

Most manual and powered staplers include a throat into which a stack of sheets is inserted for stapling. With manual staplers, the user places the stack of sheets into the throat and pushes the actuation arm of the stapler to eject the staple. The user will typically only have a rough idea of where the staple will be located with respect to the stack of sheets.

With many electric staplers, the stapling action is triggered when the stack of sheets engages an actuation switch or trips a photosensor somewhere in the throat of the stapler. The user often does not know exactly where the actuation switch or photosensor is, and therefore does not know exactly when or where the stapling will occur. This makes precise placement of the staple with respect to the stack of sheets difficult.

### SUMMARY OF THE INVENTION

The invention provides a stapler having one or more illuminated features that assist the user in guiding the stack of sheets into the stapler's throat for stapling. The illuminated features help the user intuitively position the stack of sheets in the throat to achieve the desired staple position on the stack of sheets.

In one embodiment, the lighted feature can be located in a sheet support surface adjacent the entrance of the stapler's throat. The lighted feature can take the form of a lighted centerline that is centered on the staple ejection point. By viewing the lighted centerline, the user knows precisely where the center of the staple crown will be positioned, and can position the stack of sheets laterally on the sheet support surface to achieve the desired staple position with respect to the stack of sheets. Depending on the thickness and make-up of the stack of sheets, the lighted centerline may be viewed through the stack of sheets when the stack is positioned directly over the lighted centerline.

In another embodiment, the lighted feature is located on the head of the stapler immediately above the throat. This feature can also take the form of a lighted centerline on the stapler's head that can be viewed by the user looking head-on into the throat. Additionally, the lighted centerline can extend along the underside of the stapler's head, which also defines the upper surface of the throat. Light from the lighted centerline may be seen projecting a line onto the stack of sheets as the stack is inserted into the throat. Again, this lighted centerline will facilitate the user with positioning the stack of sheets laterally to achieve the desired staple location.

In yet another embodiment, the lighted feature can take the form of an inverted, U-shaped lighted feature on the front side of the stapler's head. A user will understand that the staple will be ejected from the stapler at a point within the bounds of the inverted, U-shaped lighted feature. This feature can also be combined with the lighted centerline feature on the stapler's head to further facilitate accurate staple placement.

The stapler can further include a manual actuation button positioned on the top of the stapler. The button can be positioned substantially directly above the staple ejection opening to further assist the user in knowing where the staple will exit the stapler. The button can include an indicia (e.g., a figure of a staple) that may be illuminated.

Other features and advantages of the invention will become apparent to those skilled in the art upon review of the following detailed description and drawings.

### BRIEF DESCRIPTION OF THE DRAWINGS

FIG. 1 is a perspective view of a stapler embodying the invention.

FIG. 2 is a side view, partially in section, of the stapler of FIG. 1.

FIG. 3 is a partial top view of the stapler of FIG. 1 illustrating a stack of sheets being inserted for corner stapling.

FIG. 4 is a partial top view of the stapler of FIG. 1 illustrating a stack of sheets being inserted for straight-on stapling.

FIG. 5 is an enlarged partial side view of the stapler of FIG. 1 illustrating a stack of sheets being inserted for stapling.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of“including”, “having”, and“comprising” and variations thereof herein is meant to encompass the items listed thereafter and equivalents thereof as well as additional items.

### DETAILED DESCRIPTION OF THE PREFERRED EMBODIMENT

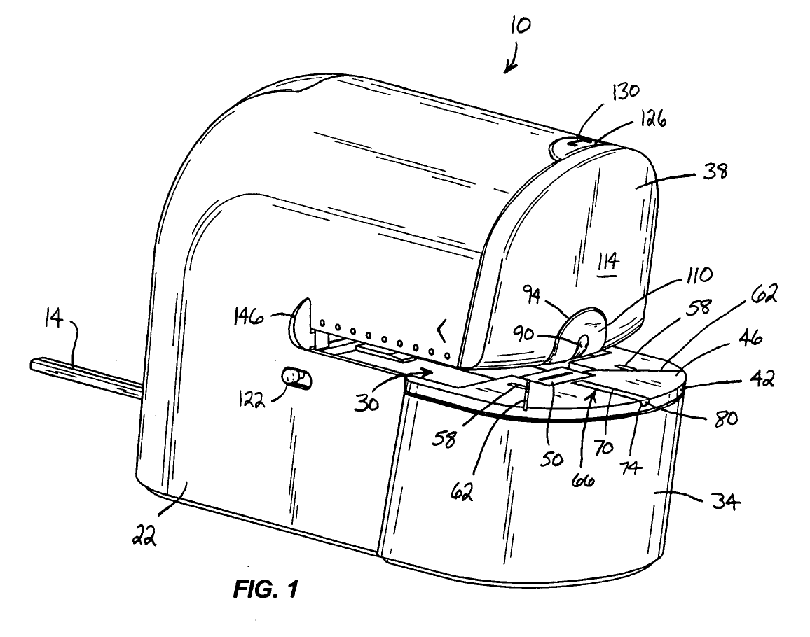

FIGS. 1-5 illustrate a stapler 10 embodying the invention. In the illustrated embodiment, the stapler 10 is a desktop-type powered stapler. However, the invention is not limited to desktop-type powered staplers, and could be practiced with other powered staplers and even with manual staplers.

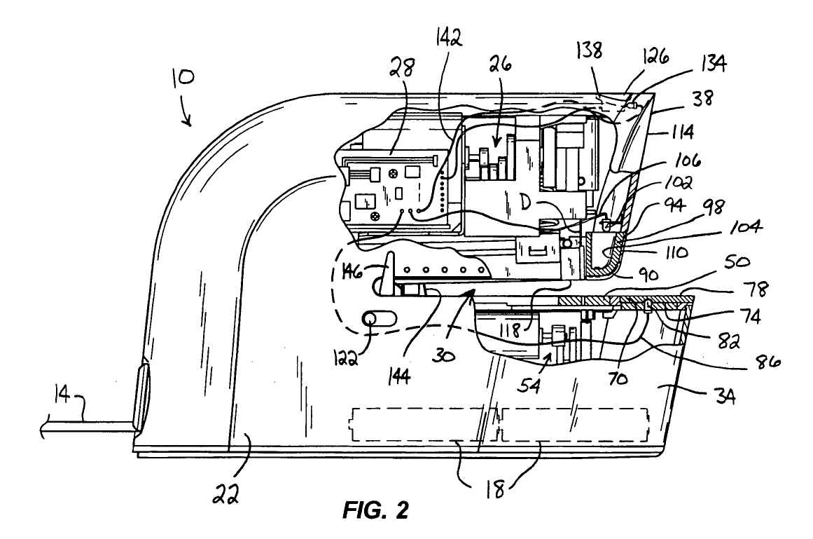

The stapler 10 is a powered stapler configured to operate under AC to DC power provided by electrical cord 14, or under DC power provided by batteries 18 (see FIG. 2). The stapler 10 includes a housing 22 that at least partially surrounds and encloses the stapler engine or drive mechanism 26. The drive mechanism 26 can take any suitable form and will not be described in greater detail. A circuit board 28 is also contained within the housing 22 and controls operation of the drive mechanism 26 and other stapler components.

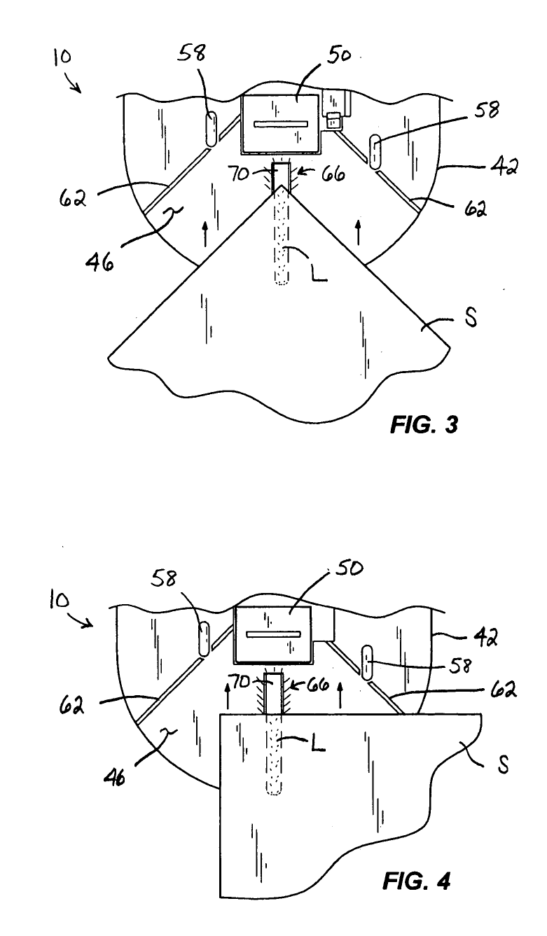

The housing 22 defines a stack insertion throat 30 into which a stack of sheets S (see FIGS. 3, 4, and 5) is inserted for stapling. The throat 30 separates the housing into a base portion 34, and a head portion 38. The base portion 34 of the housing 22 carries or defines a sheet support portion 42, having a sheet support surface 46. The sheet support portion 42 at least partially surrounds a clincher plate 50 configured to receive the legs of a staple for clinching. The clincher plate 50 is part of an active clincher assembly 54 (see FIG. 2) operable to clinch the legs of a staple below the stack of sheets S. The clincher assembly 54 can be of any suitable construction. Alternatively, the clincher assembly 54 can be replaced with a passive anvil. Together, the sheet support surface 46 and the upper surface of the clincher plate 50 define at least part of the lower surface of the throat 30.

The sheet support portion 42 includes apertures that house movable paper guides 58. The movable paper guides are described in co-pending U.S. Patent Application Serial No. XX/XXX,XXX, having Attorney Docket Number 010398-9259, entitled“Stapler with Paper Guide,” the entire contents of which is incorporated herein by reference. Paper alignment features 62 are also formed with or otherwise represented on the paper support surface 46 to further assist the user in orienting the stack of sheets S. In the illustrated embodiment, the paper alignment features 62 are grooves formed in the sheet support surface 46, but can alternatively be upstanding ridges, markings, or other suitable features on the sheet support surface 46. The features 62 define an included angle of about ninety degrees to assist the user with inserting the stack of sheets S for corner stapling.

The base portion 34 further carries or supports a first lighted feature 66 that assists the user in aligning the stack of sheets S for stapling. In the illustrated embodiment, the first lighted feature 66 takes the form of an elongated translucent member 70 supported in the sheet support portion 42. The translucent member 70 is received in a recess formed in the sheet support surface 46, and is generally semi-circular in cross-section to define a curved surface 74 received in the groove in the sheet support surface 46, and a substantially planar surface 78 that is generally co-planar with the sheet support surface 46. As seen in FIG. 1, an end surface 80 can be seen in the sheet support portion 42 when looking into the throat 30 from the front of the stapler 10. The translucent member 70 is formed of plastic, glass, or other suitable translucent materials.

A light source 82 is supported by the housing 22 and positioned adjacent to the translucent member 70 so that when the light source 82 is illuminated, the translucent member 70 is also illuminated. As illustrated in FIG. 2, the light source 82 extends at least partially into a recess in the curved surface 74 of the translucent member 70. The light source 82 is electrically connected to the circuit board 28 via a wire 86. In the illustrated embodiment, the light source 82 is an LED, however, light bulbs and other light sources can also be used.

The translucent member 70 is oriented in the sheet support surface 46 to define an illuminated centerline relative both to the clincher plate 50 and to a staple ejected from the stapler 10. In other words, the translucent member 70 defines a longitudinal axis that is substantially centered on a point in the throat 30 where the midpoint of the staple's crown will be when the staple is ejected from the stapler 10. Therefore, the translucent member 70 provides the user with a lighted feature 66 that can be used to guide the stack of sheets S to achieve the desired staple placement.

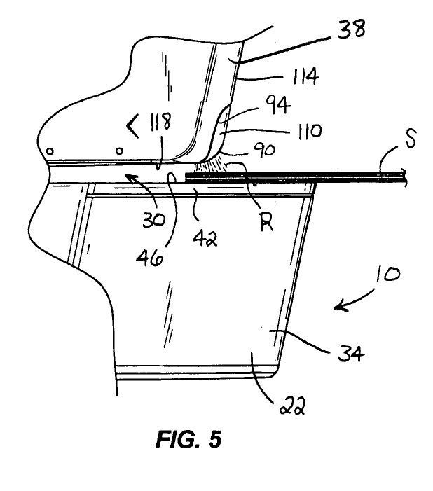

FIG. 3 illustrates a stack of sheets S being inserted into the throat 30 for corner stapling and FIG. 4 illustrates a stack of sheets S being inserted into the throat 30 for straight-on stapling. The illuminated translucent member 70 provides the user with a visual indicator representing the center of the staple that will be ejected into the stack of sheets S, thereby allowing the user to more accurately position the stack of sheets laterally on the sheet support surface 46 for insertion into the throat 30. As used herein and in any appended claims, the terms “lateral” or“laterally” refer to a direction from one side of the stapler 10 to the other side of the stapler (left to right or right to left in FIGS. 3 and 4, and into or out of the page in FIGS. 2 and 5).

Depending on the number of sheets being stapled and the thickness of the individual sheets, light from the illuminated translucent member 70 may show through the stack of sheets S, thereby providing a light band L on the stack of sheets S as an indication of the staple's centerpoint even when the stack of sheets S completely covers the translucent member 70.

Those skilled in the art will understand that the first lighted feature 66 can be achieved in other manners to provide the same illuminated centerline effect. For example, instead of using the translucent member 70, the lighted centerline feature 66 could be created using a plurality of LED's or other light sources mounted in a row in the paper support portion 42. Alternatively, a single elongated light source could also be used.

The head portion 38 of the housing 22 at least partially surrounds the drive mechanism 26 and defines at least a portion of the upper surface of the throat 30. The head portion 38 carries or supports second and third lighted features 90, 94, respectively, that further assist the user in aligning the stack of sheets S for stapling. In the illustrated embodiment, the second and third lighted features 90, 94 are created by a translucent block of material 98 housed in the front of the head portion 38 above the throat 30.

A light source 102 is positioned adjacent the translucent block 98 so that when the light source 102 is illuminated, the translucent block 98 is also illuminated. An aperture or cavity 104 formed in the block 98 functions as a light pipe to permit the light from the light source 102 to penetrate the block 98 and to illuminate the portions of the block defining the second and third lighted features 90, 94. The light source 102 is electrically connected to the circuit board 28 via a wire 106. In the illustrated embodiment, the light source 102 is an LED, however, light bulbs and other light sources can also be used.

The second and third lighted features 90, 94 are created by making a select portion of the otherwise translucent block 98 non-translucent or at least less translucent than the second and third lighted features 90, 94. As best seen in FIGS. 1 and 2, a less-translucent portion is created on the block 98 using an opaque insert or decal 110. Alternatively, the block 98 could be painted or otherwise coated to create the less-translucent portion.

The second lighted feature 90 takes the form of an illuminated centerline created by an illuminated portion of the block 98 surrounded by the opaque insert 110. As seen in FIGS. 1, 2, and 5, the illuminated centerline feature 90 extends from a front face 114 of the head portion 38 and into the throat 30 along a lower face 118 of the head portion 38. The centerline feature 90 is centered on a point in the throat 30 where the midpoint of the staple's crown will be when the staple is ejected from the stapler 10. Therefore, the illuminated centerline feature 90 facilitates proper insertion of the stack of sheets S to achieve the desired staple placement.

FIG. 5 illustrates a stack of sheets S being inserted into the throat 30 for stapling. The illuminated centerline 90 provides the user with a visual indicator representing the center of the staple that will be ejected into the stack of sheets S, thereby allowing the user to more accurately position the stack of sheets laterally on the sheet support surface 46 for insertion into the throat 30. Depending on thickness of the stack of sheets S, light from the illuminated centerline feature 90 may project (as indicated by the light rays R) onto the stack of sheets S, thereby providing an indicator of the staple's centerpoint that the user can see on the top sheet.

As best seen in FIGS. 1 and 5, the third lighted feature 94 takes the form of an illuminated, inverted U-shaped indicator created by an illuminated portion of the block 98 bounded on the inside by the opaque insert 110 and on the outside by the remainder of the opaque front face 114 of the head portion 38. The legs of the U-shaped indicator can extend into the throat 30 in a manner similar to the illuminated centerline 90, such that light may be projected onto the top sheet. A user will understand that the staple will be ejected from the stapler 10 at a point within the bounds (i.e., between the legs) of the inverted, U-shaped lighted feature. Viewed in combination with the illuminated centerline 90, the user will have an accurate indication of where the staple will be positioned with respect to the stack of sheets S.

Those skilled in the art will understand that the second and third lighted features 90, 94 can be achieved in other manners to provide the same illuminated effects. For example, a separate block of translucent material could be used for each of the features 90, 94, instead of using the single block 98. Alternatively, the features 90, 94 could be created using a plurality of LED's or other light sources mounted in the head portion 38. In another alternative, a single elongated light source could also be used for the centerline feature 90 and a curved light source could be for the inverted, U-shaped feature 94.

The stapler 10 of the illustrated embodiment is operable in an automatic mode or a manual mode. A mode selector switch 122 is provided on the stapler 10 to allow the user to change between the automatic and manual modes. In the manual operating mode, the user actuates the staple driving mechanism 26 by depressing an actuation button 126 when the stack of sheets S is in the desired position. As illustrated in FIGS. 1 and 2, the actuation button 126 is located on the top surface of the head portion 38, is generally centrally positioned laterally on the top of the stapler 10, and is generally vertically aligned with the staple exit location, as indicated by the staple driver D.

Unlike many powered staplers that have an actuation button on a side or the rear of the stapler, the location of the actuation button 126 on the stapler 10 provides yet another intuitive staple locating feature. Specifically, by positioning the actuation button 126 generally directly above the staple exit location, the user operating the stapler 10 understands where the staple will be located with respect to the stack of sheets S and can even visualize the staple exiting the stapler generally in line with the finger being used to depress the button 126.

In the illustrated embodiment, the button 126 includes an indicia 130 representative of a staple to alert the user that the button 126 is used to actuate the stapler 10 in the manual operation mode. The indicia 130 provides another visual indicator of the approximate staple exit location. As illustrated in FIG. 2, the indicia 130 is illuminated by a light source 134 positioned adjacent a translucent block 138 that, along with the surrounding structure of the button 126, defines the indicia 130. Alternatively, the button structure itself can be made of a translucent material having an opaque insert, decal, or coating that defines the indicia 130. The light source 134 is electrically connected to the circuit board 28 via a wire 142. In the illustrated embodiment, the light source 134 is an LED, however, light bulbs and other light sources can also be used. It is further understood that the indicia 130 need not be illuminated, can take other forms, or can be eliminated altogether.

In the automatic operating mode, the staple driving mechanism 26 is actuated when the stack of sheets contacts or otherwise trips a switch 144 (see FIG. 2). In the illustrated embodiment, the switch 144 is a spring-trigger mechanism. However, it is understood that in other embodiments the switch could include a photosensor or other suitable device for actuating the driving mechanism 26.

With reference to FIGS. 1 and 2, the switch 144 is movable with a throat depth guide 146 that is coupled to the housing 22 for movement in the throat 30. The throat depth guide 146 allows the user to vary the staple location with respect to an edge of the stack of sheets S, as is commonly understood.

Whether the user is operating the stapler 10 in the manual or the automatic mode, the lighted features 66, 90, and 94 separately and in combination facilitate the insertion of the stack of sheets S to achieve accurate staple placement. It is also understood that the illustrated lighted features 66, 90, and 94 are only a few of the possibilities for lighted features that facilitate paper positioning and insertion. For example, instead of the features 66 and 90 being in the form of illuminated lines centered on the midpoint of the location where a staple exits the stapler 10 (i.e., as represented by the midpoint of the clincher plate 50), the features could each take the form of two separate illuminated lines generally aligned with the respective locations where the staple legs will exit the stapler 10, thereby showing the user the lateral endpoints of the staple location. This configuration would be similar to the configuration as represented by the legs of the inverted, U-shaped feature 94, but with the double illuminated lines being located in the sheet support surface 46 and the lower surface 118 adjacent the throat 30.

In another alternative, the illuminated centerline features 66 and 90 could be widened to be substantially the same width as the crown of the staple being driven. Other illuminated features could also be used on the sheet support surface 46. For example, the paper alignment features 62 could be illuminated in a similar manner to the illuminated features 66, 90, or 94 to provide illuminated sheet comer alignment features. Additionally, illuminated features could be spaced at lateral intervals along the sheet support surface 46 to provide alignment guides for the left edge or right edge of a stack of sheets S being inserted into the throat 30.

Various features of the invention are set forth in the following claims.

1. A stapler comprising:
a housing at least partially defining a stack insertion throat into which a stack of sheets can be inserted for stapling; and
a lighted alignment element adjacent the stack insertion throat, the lighted alignment element configured to assist a user in positioning the stack of sheets in the stack insertion throat for stapling.

2. The stapler of claim 1, wherein the housing includes a head portion on one side of the stack insertion throat and a base portion on the opposite side of the stack insertion throat, the base portion including a sheet support portion for supporting the stack of sheets, and wherein the lighted alignment element is on one of the head portion and the sheet support portion.

3. The stapler of claim 2, wherein the stapler includes a first lighted alignment element on the sheet support portion and a second lighted alignment element on the head portion.

4. The stapler of claim 1, wherein the lighted alignment element defines an illuminated centerline substantially centered with respect to a point in the throat where the midpoint of an ejected staple would be located.

5. The stapler of claim 4, wherein the housing includes a head portion on one side of the stack insertion throat and a base portion on the opposite side of the stack insertion throat, the base portion including a sheet support portion for supporting the stack of sheets, and wherein the illuminated centerline is on one of the head portion and the sheet support portion.

6. The stapler of claim 1, wherein the lighted alignment element defines an illuminated, generally inverted U-shaped indicator substantially centered with respect to a staple ejection location of the stapler such that an ejected staple would be aligned with legs of the inverted U-shaped indicator.

7. The stapler of claim 6, wherein the housing includes a head portion on one side of the stack insertion throat and a base portion on the opposite side of the stack insertion throat, and wherein the inverted U-shaped indicator is on the head portion.

8. The stapler of claim 1, wherein the lighted alignment element is defined at least in part by a translucent member at least partially illuminated by a light source positioned adjacent the translucent member.

9. The stapler of claim 8, wherein the translucent member is elongated.

10. The stapler of claim 8, wherein the translucent member is a block.

11. The stapler of claim 10, wherein the translucent block includes a cavity formed therein.

12. The stapler of claim 10, wherein at least a portion of the translucent block is rendered less translucent than a portion of the translucent block defining the lighted alignment element.

13. The stapler of claim 1, further comprising an actuation button positioned generally directly above a staple exit location.

14. The stapler of claim 13, wherein the actuation button includes an illuminated indicia.

15. A stapler comprising:
a housing at least partially defining a stack insertion throat into which a stack of sheets can be inserted for stapling, the housing including a head portion on one side of the stack insertion throat and a base portion on the opposite side of the stack insertion throat, the base portion including a sheet support portion for supporting the stack of sheets; and
a lighted alignment element on a surface of the sheet support portion adjacent the stack insertion throat, the lighted alignment element configured to assist a user in positioning the stack of sheets in the stack insertion throat for stapling.

16. The stapler of claim 15, wherein the lighted alignment element is defined at least in part by a translucent member at least partially illuminated by a light source positioned adjacent the translucent member.

17. The stapler of claim 15, wherein the lighted alignment element defines an illuminated centerline substantially centered with respect to a point in the throat where the midpoint of an ejected staple would be located.

18. A stapler comprising:
a housing at least partially defining a stack insertion throat into which a stack of sheets can be inserted for stapling, the housing including a head portion on one side of the stack insertion throat and a base portion on the opposite side of the stack insertion throat, the base portion including a sheet support portion for supporting the stack of sheets; and
a lighted alignment element on a surface of the head portion adjacent the stack insertion throat, the lighted alignment element configured to assist a user in positioning the stack of sheets in the stack insertion throat for stapling.

19. The stapler of claim 18, wherein the lighted alignment element is defined at least in part by a translucent member at least partially illuminated by a light source positioned adjacent the translucent member.

20. The stapler of claim 18, wherein the lighted alignment element is at least one of an illuminated centerline substantially centered with respect to a point in the throat where the midpoint of an ejected staple would be located, and an illuminated, generally inverted U-shaped indicator substantially centered with respect to a staple ejection location of the stapler such that an ejected staple would be aligned with legs of the inverted U-shaped indicator.
